(19) United States
(12) Patent Application Publication
(10) Pub. No.: US 2011/0098153 A1
(43) Pub. Date: Apr. 28, 2011

(54) VEHICLE CONTROL APPARATUS

(75) Inventors: Yukihisa TSUZUKI, Kariya-shi (JP); Yosuke Makino, Anjo-shi (JP); Tomoko Yamamoto, Chiryu-shi (JP); Tomoyuki Kitagawa, Anjo-shi (JP)

(73) Assignee: AISIN SEIKI KABUSHIKI KAISHA, Acihi-ken (JP)

(21) Appl. No.: 12/893,249

(22) Filed: Sep. 29, 2010

(30) Foreign Application Priority Data
Oct. 23, 2009 (JP) 2009-244079

(51) Int. Cl. B60W 10/02; F16H 61/14

(52) U.S. Cl. 477/168

(57) ABSTRACT

A vehicle control apparatus that controls a vehicle having a torque converter provided on a power transmission path between an internal combustion engine and a transmission is provided. The torque converter includes a pump impeller, to which rotational power from the internal combustion engine is input to rotate, a turbine runner that receives oil from the rotating pump impeller and transmits the rotational power toward the transmission, and an impeller clutch that is configured to connect and disconnect the rotational power transmission from the internal combustion engine to the pump impeller. The vehicle control apparatus controls the internal combustion engine and the impeller clutch, such that, when a rotation number of the internal combustion engine is equal to or less than a first threshold value during control of the impeller clutch from a non-engaged state to a completely engaged state, increases the rotation number of the internal combustion engine.

### CROSS REFERENCE TO RELATED APPLICATIONS

This application is based on and claims priority under 35 U.S.C. §119 to Japanese Patent Application 2009-244079, filed on Oct. 23, 2009, the entire content of which is incorporated herein by reference.

### TECHNICAL FIELD

This disclosure relates to a vehicle control apparatus that controls a vehicle having a clutch provided on a power transmission path between an internal combustion engine and a torque converter, and more particularly, to a vehicle control apparatus that controls the internal combustion engine and the torque converter at the time of start moving.

### BACKGROUND DISCUSSION

In an automatic transmission, a torque converter capable of continuously transmitting torque of a power source from a stall state to a direct-coupled state is provided on a power transmission path between an internal combustion engine and a torque converter. There is a torque converter having a lock-up clutch that directly couples a pump impeller and a turbine runner to remove a rotation number difference between the internal combustion engine and the turbine runner so as to improve a fuel efficiency during driving when a rotation number difference between the pump impeller and the turbine runner is small. Further, among such torque converters, there is a torque converter having a mechanism (hereinafter, referred to as impeller clutch) that can separate the pump impeller from the internal combustion engine so as to reduce fluid resistance between the turbine runner and the pump impeller for the purpose of reducing fuel consumption during an idling.

Regarding control of such a vehicle having the impeller clutch, for example, JP-A-2009-115308 discloses a clutch operating method including, in order to achieve a turbo charge spool-up at the time of start moving, a step of increasing a first liquid pressure in an inside chamber from a first level to a second level, such that the first liquid pressure forces to move a clutch, which is provided between an engine of the vehicle and an impeller for a torque converter of the vehicle, to a connection position, and a step of decreasing a second liquid pressure in an outside chamber from a third level to a fourth level as a function of an engine speed, such that the second liquid pressure corresponds to the first liquid pressure.

When the torque converter having the impeller clutch is applied to a vehicle with no turbo lag, it is required to engage the impeller clutch in a short time at the time of the start moving, so as to improve a response. However, when the clutch operating method disclosed in JP-A-2009-115308 is applied to the vehicle with no turbo lag, if the impeller clutch is engaged in a short time at the time of start moving, the rotational speed of the internal combustion engine is reduced and the internal combustion engine may be thus stopped. In addition, a driver may feel a sense of incompatibility due to a change of the engine rotation.

A need thus exists for a vehicle control apparatus that avoids stop of an internal combustion engine even when an impeller clutch is engaged in a short time at the time of start moving in a vehicle with no turbo lag, and prevents a driver from feeling a sense of incompatibility due to a change of engine rotation.

### SUMMARY

According to an aspect of this disclosure, there is provided a vehicle control apparatus that controls a vehicle having a torque converter provided on a power transmission path between an internal combustion engine and a transmission. The torque converter includes a pump impeller, to which rotational power from the internal combustion engine is input to rotate, a turbine runner that receives oil from the rotating pump impeller and transmits the rotational power toward the transmission, and an impeller clutch that is configured to connect and disconnect the rotational power transmission from the internal combustion engine to the pump impeller. The vehicle control apparatus controls the internal combustion engine and the impeller clutch, such that, when a rotation number of the internal combustion engine is equal to or less than a first threshold value during control of the impeller clutch from a non-engaged state to a completely engaged state, increases the rotation number of the internal combustion engine.

### BRIEF DESCRIPTION OF THE DRAWINGS

The foregoing and additional features and characteristics of this disclosure will become more apparent from the following detailed description considered with the reference to the accompanying drawings, wherein:

FIG. 1 schematically shows a configuration of a vehicle control apparatus according to an illustrative embodiment 1 disclosed here;

FIG. 2 is a flow chart that schematically shows an operation of the vehicle control apparatus according to the illustrative embodiment 1 disclosed here; and

FIG. 3 is a flow chart that schematically shows an operation of a vehicle control apparatus according to an illustrative embodiment 2 disclosed here.

### DETAILED DESCRIPTION

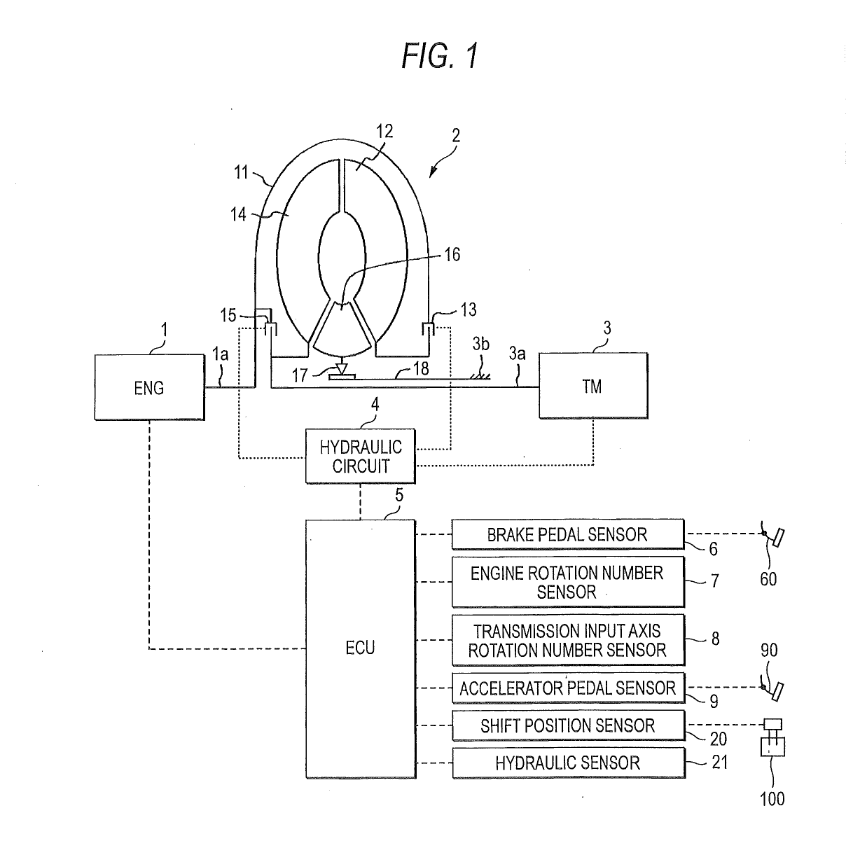

According to illustrative embodiments of the invention, there is provided a vehicle control apparatus 5 (FIG. 1) that controls a vehicle having a torque converter 2 (FIG. 1) provided on a power transmission path between an internal combustion engine 1 (FIG. 1) and a transmission 3 (FIG. 1). The torque converter includes a pump impeller 12 (FIG. 1), to which rotational power from the internal combustion engine is input to rotate, a turbine runner 14 (FIG. 1) that receives oil from the rotating pump impeller and transmits the rotational power toward the transmission, and an impeller clutch 13 (FIG. 1) that can connect and disconnect the rotational power transmission from the internal combustion engine to the pump impeller. The vehicle control apparatus controls the internal combustion engine and the impeller clutch, such that when a rotation number of the internal combustion engine is equal to or less than a preset threshold value during control of the impeller clutch from a non-engaged state to a completely engaged state, increases the rotation number of the internal combustion engine.

### Illustrative Embodiment 1

A vehicle control apparatus according to an illustrative embodiment 1 disclosed here will be described with reference to the drawing. FIG. 1 schematically shows a configuration of the vehicle control apparatus according to the illustrative embodiment 1 disclosed here.

Referring to FIG. 1, the vehicle has a torque converter 2 on a power transmission path between an engine 1 and a transmission 3, a hydraulic circuit 4 that hydraulically controls engagement elements of the torque converter 2 and the transmission 3, and an electronic control unit 5 that electronically controls the engine 1 and the hydraulic circuit 4. The electronic control unit 5 is a vehicle control apparatus and controls actuators in the engine 1 to perform an idle up control and controls the hydraulic circuit 4 to control connection and disconnection of an impeller clutch 13 of the torque converter 2. Herein, the idle up control means a control of increasing the rotation number by a predetermined rotation number (for example, about 100 rpm) when the engine 1 is idling.

The engine 1 is an internal combustion engine that burns fuel (for example, hydrocarbon-based fuel such as gasoline and diesel) to output rotational power from a crank shaft 1a. The rotational power of the crank shaft 1a is transmitted to a converter shell 11 of the torque converter 2. The engine 1 has a variety of sensors and actuators, is communicably connected to the electronic control unit 5 and is controlled by the electronic control unit 5.

The torque converter 2 is a fluid power transmission that uses a mechanical action of fluid to generate a torque amplification action by a rotation difference between a pump impeller 12 of an input side and a turbine runner 14 of an output side. The torque converter 2 is provided on a power transmission path between the crack shaft 1a and a transmission input axis 3a. The torque converter 2 has the converter shell 11, the pump impeller 12, an impeller clutch 13, the turbine runner 14, a lock-up clutch 15, a stator 16, a one-way clutch 17 and a stator shaft 18.

The converter shell 11 is a casing of the torque converter 2. The converter shell 11 is integrally rotated with the crank shaft 1a at all times. Each constitutional unit of the torque converter 2 and oil are provided in the internal space of the converter shell 11. The converter shell 11 is configured to be rotatable relative to the pump impeller 12. However, the converter shell 11 is rotated integrally with the pump impeller 12 by being engaged with the impeller clutch 13. Further, the converter shell 11 is configured to be rotatable relative to the turbine runner 14. However, the converter shell 11 is rotated integrally with the turbine runner 14 by being engaged with the lock-up clutch 15.

The pump impeller 12 is an impeller that flows oil toward the turbine runner 14 by rotation. The pump impeller 12 is configured to be rotatable relative to the converter shell 11. However, the pump impeller 12 is integrally rotated with the converter shall 11 by being engaged with the impeller clutch 13.

The impeller clutch 13 is a clutch mechanism (friction-engagement element) that separates the pump impeller 12 from the engine 1 so as to reduce fluid resistance between the turbine runner 14 and the pump impeller 12 for a purpose of reducing fuel consumption during an idling. The impeller clutch 13 is engaged, so that it transmits the rotational power of the converter shell 11 to the pump impeller 12. The connection and disconnection of the impeller clutch 13 is controlled by the electronic control unit 5 through the hydraulic circuit 4.

The turbine runner 14 is an impeller that receives oil flowed from the pump impeller 12 and is thus rotated. The turbine runner 14 is integrally rotated with the transmission input axis 3a at all times. The turbine runner 14 is configured to be rotatable relative the converter shell 11. However, the turbine runner 14 is rotated integrally with the converter shell 11 by being engaged with the lock-up clutch 15.

The lock-up clutch 15 is a clutch mechanism (friction engagement element) that directly couples the pump impeller 12 and the turbine runner 14 to remove a rotation number difference between the engine 1 and the turbine runner 14 when a rotation number difference between the pump impeller 12 and the turbine runner 13 is small. The lock-up clutch 15 is engaged, so that it transmits the rotational power of the converter shell 11 to the turbine runner 14 and the transmission input axis 3a. The connection and disconnection of the lock-up clutch 15 is controlled by the electronic control unit 5 through the hydraulic circuit 4.

The stator 16 is an impeller that is provided at a position of an inner periphery between the turbine runner 14 and the pump impeller 12 and rectifies and causes the oil, which is discharged from the turbine runner 14, to reflow to the pump impeller 12, thereby generating a torque amplification action. The stator 16 is fixed to a transmission case 3b through the one-way clutch 17 and the stator shaft 18 and is configured to be rotated only in one direction.

The one-way clutch 17 is a clutch that causes the stator 16 to rotate only in one direction. A rotational end of the one-way clutch 17 is fixed with the stator 16. A fixing end of the one-way clutch 17 is fixed to the transmission case 3b through the stator shaft 18.

The stator shaft 18 is a shaft-type member that fixes the fixing end of the one-way clutch 17 to the transmission case 3b.

The transmission 3 is a mechanism that changes and then outputs the rotational power, which is input from the transmission input axis 3a, toward a driving wheel (not shown). In the transmission 3, the rotational power output from the engine 1 is input to a planetary gear mechanism (a combination of planetary gear mechanisms) through the torque converter 2 and is changed and output by the planetary gear mechanism. The transmission 3 configures a plurality of shift stages in accordance with combinations of engagement and non-engagement of a plurality of friction engagement elements (clutch and brake; not shown). The connection and disconnection of each friction engagement element of the transmission 3 is controlled by the electronic control unit 5 through the hydraulic circuit 4.

The hydraulic circuit 4 is a circuit that controls the hydraulic pressure to be supplied to the friction engagement elements (including the impeller clutch 13 and the lock-up clutch 15) of the torque converter 2 and the transmission 3. The hydraulic circuit 4 is configured to switch oil paths (not shown) by a valve (not shown), and has a plurality of electronic valves (not shown), which are driven by a control signal from the electronic control unit 5. The electronic valves control a line pressure supplied from the oil pump to switch the oil paths or to control the engagement and opening (non-engagement) of the friction engagement elements (including the impeller clutch 13 and the lock-up clutch 15) of the torque converter 2 and the transmission 3.

The electronic control unit 5 is a computer that controls operations of the friction engagement elements (including the impeller clutch 13 and the lock-up clutch 15) of the torque converter 2 and the transmission 3 through the hydraulic circuit 4. The electronic control unit 5 is communicably connected to a brake pedal sensor 6, an engine rotation number sensor 7, a transmission input axis rotation number sensor 8, an accelerator pedal sensor 9, a shift position sensor 20, and a hydraulic sensor 21. The electronic control unit 5 detects vehicle states (a pedaled degree of a brake, the engine rotation number, the transmission input axis rotation number, an opening degree of the accelerator and the like) based on detection signals from the various sensors and control signals of the various actuators (including the electronic valves). The electronic control unit 5 transmits a control signal that controls the output (the rotation number, torque) of the engine 1, based on stored programs and database (maps, threshold values), in response to the vehicle states. The electronic control unit 5 transmits a control signal that controls the electronic valves (not shown) of the hydraulic circuit 4, so as to control the change of speed of the transmission 3 or the connection and disconnection of the impeller clutch 13 and the lock-up clutch 15 based on the stored programs and database (maps, threshold values), in response to the vehicle states. The detailed control operation of the electronic control unit 5 will be described below.

The brake pedal sensor 6 is a sensor that detects a pedaling stroke of a brake pedal 60 in a driver's space and functions as a start intention detection sensor that detects a driver's intention to start the vehicle. The brake pedal sensor 6 detects that there is a driver's intention to start the vehicle when the pedaling of the brake pedal 60 is released. The brake pedal sensor 6 is communicably connected to the electronic control apparatus 5.

It is noted that, a shift position sensor 20 that detects a shift position by a shift lever, such as L range, R range, N range, P range and D range, or the accelerator pedal sensor 9 may be used as the start intention detection sensor instead of the brake pedal sensor 6. The shift position sensor 20 detects that there is a driver's intention to start the vehicle when the shift lever 100 is shifted to the D range from the N range, for example. The accelerator pedal sensor 9 detects that there is a driver's intention to start the vehicle when an accelerator pedal 90 is stepped on. Meanwhile, a driver's intention to start the vehicle may be determined with a plurality of sensors, rather than one sensor only.

The engine rotation number sensor 7 is a sensor that detects the rotation number of the crank shaft 1a of the engine 1 (engine rotation number). The engine rotation number sensor 7 is communicably connected to the electronic control unit 5.

The transmission input axis rotation number sensor 8 is a sensor that detects the rotation number of the transmission input axis 3a (transmission input axis rotation number). The transmission input axis rotation number sensor 8 is communicably connected to the electronic control unit 5.

The accelerator pedal sensor 9 is a sensor that detects a pedaling stroke of an accelerator pedal 90 in a driver's space to thus detect a throttle opening degree. The transmission input axis revolution-number sensor 8 is communicably connected to the electronic control unit 5.

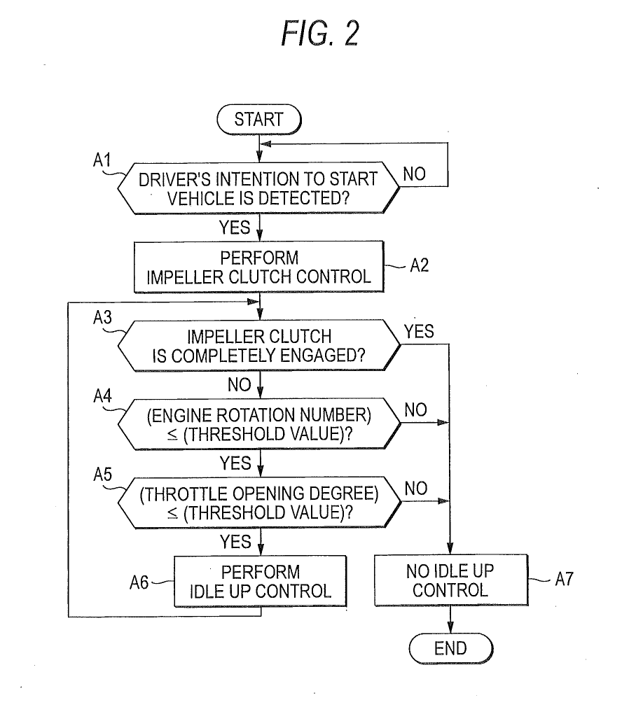

Next, an operation of the vehicle control apparatus according to the illustrative embodiment 1 disclosed here will be described with reference to the drawing. FIG. 2 is a flow chart that schematically shows the operation of the vehicle control apparatus according to the illustrative embodiment 1 disclosed here. It is assumed, at the time of start moving, that the vehicle is stopped, the engine 1 is being rotating and the impeller clutch 13 and the lock-up clutch 15 are opened.

First, the electronic control unit 5 determines whether a driver's intention to start the vehicle is detected using the start intention detection sensor (brake pedal sensor 6 in FIG. 1) (step A1). When a driver's intention to start the vehicle is not detected (NO in step A1), the operation returns to step A1.

When a driver's intention to start the vehicle is detected (YES in step A1), the electronic control sensor 5 performs the control of shifting the impeller clutch 13 from an opened state to an engaged state (step A2).

Following step A2 or step A6, the electronic control unit 5 determines whether the impeller clutch 13 is completely engaged (step A3). When the impeller clutch 13 is completely engaged (YES in step A3), the operation proceeds to step A7 with the impeller clutch 13 being completely engaged.

Herein, the determination of whether the impeller clutch 13 is completely engaged is made based on a determination of whether a difference between the engine rotation number, which is detected by the engine rotation number sensor 7 in FIG. 1, and the transmission input axis revolution number, which is detected by the transmission input axis revolution-number sensor 8, is removed (or the difference becomes equal to or less than a threshold value). When the difference is removed, it is determined that the impeller clutch 13 is completely engaged.

It is noted that the configuration for determining whether the impeller clutch 13 is completely engaged is not limited to the above-described configuration of determination based on the engine rotation number sensor 7 and the transmission input axis rotation number sensor 8. For example, whether the impeller clutch 13 is completely engaged may be determined, using a detection signal of a hydraulic sensor 21 that detects a hydraulic pressure enabling the impeller clutch 13 to be engaged or a control signal (relating to the impeller clutch 13) for the hydraulic circuit 4 of the electronic control unit 5.

When the impeller clutch 13 is not completely engaged (NO in step A3), the electronic control unit 5 determines whether the engine rotation number is equal to or less than a preset threshold value, using the engine rotation number sensor 7 (step A4). When the engine rotation number is larger than a preset threshold value (NO in step A4), the operation proceeds to step A7.

When the engine rotation number is equal to or less than the preset threshold value (YES in step A4), the electronic control unit 5 determines whether the throttle opening degree, which a driver requests, is equal to or less than a preset threshold value, using the accelerator pedal sensor 9 (step A5). When the throttle opening degree is larger than the preset threshold value (NO in step A5), the operation to step A7.

When the throttle opening degree is equal to or less than the preset threshold value (YES in step A5), since there is a worry that the rotational speed of the engine 1 may be decreased, the electronic control unit 5 performs the idle up control for the engine 1 (starts the idle up control when the idle up control is not performed or continues the idle up control when the idle up control has already been performed) (step A6) and then returns to step A3. At this time, although the impeller clutch 13 is rapidly engaged so as to suppress a time lag at the time of start moving, a slippage occurs between the pump impeller 12 and the turbine runner 14 on the power transmission path at a rear side of the impeller clutch 13, so that the shock transfer to the driver is suppressed. Further, the engine 1 is subject to the idle up control, so that the engine rotation number is suppressed from being reduced and the engine 1 is thus prevented from being stopped. Meanwhile, in the idle up control, the engine 1 is controlled so that the engine rotation number becomes the engine rotation number obtained by adding 100 rpm to the engine rotation number before the engagement of the impeller clutch, for example.

When the impeller clutch 13 is completely engaged (YES in step A3), when the engine rotation number is larger than the threshold value (NO in step A4) or when the throttle opening degree is larger than the threshold value (NO in step A5), there is no worry that the rotational speed of the engine 1 is decreased. Therefore, the electronic control unit 5 does not perform the idle up control for the engine 1 (maintain not performing the idle up control when the idle up control is not performed or stops the idle up control when the idle up control has been already performed) (step A7) and then ends the process.

According to the illustrative embodiment 1, while the impeller clutch 13 is rapidly engaged so as to suppress the time lag at the time of start moving, the engine 1 is subject to the idle up control when the engine rotation number is small and the throttle opening degree is small. Thus, the reduction of the engine rotation number is suppressed, so that it is possible to avoid the stopping of the engine 1 and to prevent a driver from feeling a sense of incompatibility due to a change of engine rotation. In addition, since a slippage occurs between the pump impeller 12 and the turbine runner 14 on the power transmission path at a rear side of the impeller clutch 13, the shock transfer to the driver is suppressed even when the engine 1 is subject to the idle up control.

### Illustrative Embodiment 2

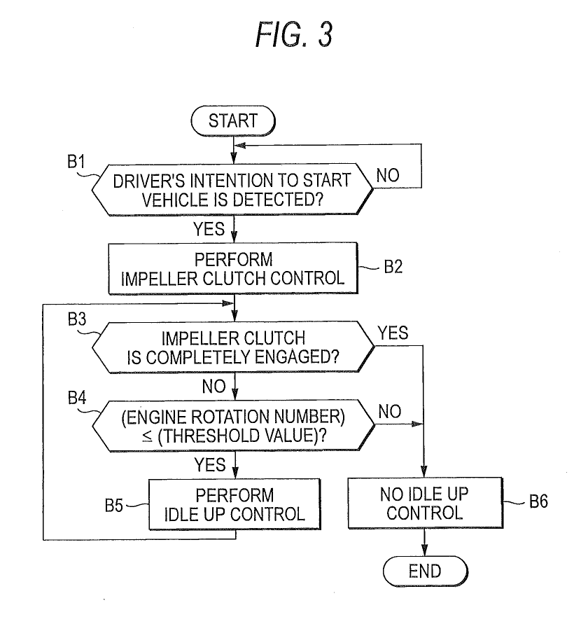

A vehicle control apparatus according to an illustrative embodiment 2 disclosed here will be described with reference to the drawing. FIG. 3 is a flow chart that schematically shows the operation of the vehicle control apparatus according to the illustrative embodiment 2 disclosed here.

In the illustrative embodiment 2, the determination of whether the throttle opening degree is equal to or less than a threshold value (step A5 in FIG. 2), which is performed in the illustrative embodiment 1, is omitted. In other words, steps B1 to B4 are the same as steps A1 to A4. When the engine rotation number is equal to or less than a threshold value (YES in step B4), the electronic control unit 5 performs the idle up control for the engine 1 (starts the idle up control when the idle up control is not performed or continues the idle up control when the idle up control has already been performed) (step B5) and then returns to step B3. When the impeller clutch 13 is completely engaged (YES in step B3) or when the engine rotation number is larger than the threshold value (NO in step B4), the electronic control unit 5 does not perform the idle up control for the engine 1 (maintain not performing the idle up control when the idle up control is not performed or stops the idle up control when the idle up control has been already performed) (step B6) and then ends the process. It is noted that, the configuration of the illustrative embodiment 2 is similar to that of the illustrative embodiment 1 (refer to FIG. 1).

According to the illustrative embodiment 2, the same effects as those of the illustrative embodiment 1 are obtained. Further, since the information processing steps in the electronic control unit 5 are reduced, the high speed processing is possible as much and it is possible to prevent the engine 1 from being stopped.

It is provided illustrative, non-limiting embodiments as follows:

A vehicle control apparatus controls a vehicle having a torque converter provided on a power transmission path between an internal combustion engine and a transmission. The torque converter includes a pump impeller, to which rotational power from the internal combustion engine is input to rotate, a turbine runner that receives oil from the rotating pump impeller and transmits the rotational power toward the transmission, and an impeller clutch that is configured to connect and disconnect the rotational power transmission from the internal combustion engine to the pump impeller. The vehicle control apparatus controls the internal combustion engine and the impeller clutch, such that, when a rotation number of the internal combustion engine is equal to or less than a first threshold value during control of the impeller clutch from a non-engaged state to a completely engaged state, increases the rotation number of the internal combustion engine.

In the above vehicle control apparatus, when the rotation number of the internal combustion engine is equal to or less than the first threshold value and a throttle opening degree is equal to or less than a second threshold value during the control of the impeller clutch from the non-engaged state to the completely engaged state, the vehicle control apparatus may increase the rotation number of the internal combustion engine.

In the above vehicle control apparatus, the completely engaged state of the impeller clutch may be detected by an internal combustion engine rotation number sensor that detects the rotation number of the internal combustion engine and a transmission input axis rotation number sensor that detects a rotation number to be input to the transmission.

In the above vehicle control apparatus, the vehicle control apparatus may control the impeller clutch through a hydraulic circuit. The completely engaged state of the impeller clutch may be detected by a hydraulic sensor that detects a hydraulic pressure to be supplied to the impeller clutch, in the hydraulic circuit.

In the above vehicle control apparatus, the completely engaged state of the impeller clutch may be detected by a control signal for the impeller clutch.

In the above vehicle control apparatus, the vehicle control apparatus may start to control the impeller clutch from the non-engaged state to the completely engaged state when detecting a driver's intention to start the vehicle.

In the above vehicle control apparatus, the driver's intention to start the vehicle may be detected based on at least one operation of a brake pedal, an accelerator pedal and a shift lever.

According to the above-described configuration, while the impeller clutch is rapidly engaged so as to suppress a time lag when starting a vehicle, the control (idle up control) of increasing the rotation number of the internal combustion engine is performed when a throttle opening degree is small (the rotation number of the internal combustion engine is small). Thereby, the rotation number of the internal combustion engine is suppressed from being decreased, so that it is possible to avoid the stopping of the internal combustion engine and to prevent a driver from feeling a sense of incompatibility due to a change of engine rotation. Further, since a slippage occurs between the pump impeller and the turbine runner on the power transmission path at a rear side of the impeller clutch, the shock transfer to the driver is suppressed even when the idle up control is performed for the internal combustion engine.

The principles, preferred embodiment and mode of operation of the present invention have been described in the foregoing specification. However, the invention which is intended to be protected is not be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within spirit and scope of the present invention as defined in the claims, be embraced thereby.

What is claimed is:

1. A vehicle control apparatus that controls a vehicle having a torque converter provided on a power transmission path between an internal combustion engine and a transmission,
wherein the torque converter includes a pump impeller, to which rotational power from the internal combustion engine is input to rotate, a turbine runner that receives oil from the rotating pump impeller and transmits the rotational power toward the transmission, and an impeller clutch that is configured to connect and disconnect the rotational power transmission from the internal combustion engine to the pump impeller, and
wherein the vehicle control apparatus controls the internal combustion engine and the impeller clutch, such that, when a rotation number of the internal combustion engine is equal to or less than a first threshold value during control of the impeller clutch from a non-engaged state to a completely engaged state, increases the rotation number of the internal combustion engine.

2. The vehicle control apparatus according to claim 1,
wherein when the rotation number of the internal combustion engine is equal to or less than the first threshold value and a throttle opening degree is equal to or less than a second threshold value during the control of the impeller clutch from the non-engaged state to the completely engaged state, the vehicle control apparatus increases the rotation number of the internal combustion engine.

3. The vehicle control apparatus according to claim 1,
wherein the completely engaged state of the impeller clutch is detected by an internal combustion engine rotation number sensor that detects the rotation number of the internal combustion engine and a transmission input axis rotation number sensor that detects a rotation number to be input to the transmission.

4. The vehicle control apparatus according to claim 1,
wherein the vehicle control apparatus controls the impeller clutch through a hydraulic circuit, and
wherein the completely engaged state of the impeller clutch is detected by a hydraulic sensor that detects a hydraulic pressure to be supplied to the impeller clutch, in the hydraulic circuit.

5. The vehicle control apparatus according to claim 1,
wherein the completely engaged state of the impeller clutch is detected by a control signal for the impeller clutch.

6. The vehicle control apparatus according to claim 1,
wherein the vehicle control apparatus starts to control the impeller clutch from the non-engaged state to the completely engaged state when detecting a driver's intention to start the vehicle.

7. The vehicle control apparatus according to claim 1,
wherein the driver's intention to start the vehicle is detected based on at least one operation of a brake pedal, an accelerator pedal and a shift lever.
